(19) United States
(12) Patent Application Publication
(10) Pub. No.: US 2015/0278372 A1
(43) Pub. Date: Oct. 1, 2015

(54) Search Engine and Network for Enhancing Search of Information Over a Data Network

(71) Applicant: Mohammed Nasser Ali Ibrahim Al Balooshi, Abu Dhabi (AE)

(72) Inventor: Mohammed Nasser Ali Ibrahim Al Balooshi, Abu Dhabi (AE)

(21) Appl. No.: 14/289,409

(22) Filed: May 28, 2014

Related U.S. Application Data
(62) Division of application No. 14/227,926, filed on Mar. 27, 2014.

(51) Int. Cl. G06F 17/30

(52) U.S. Cl. CPC G06F 17/30867

(57) ABSTRACT

There is provided a search engine for enhancing search of subject related information distributed over a data network, the search engine being adapted to be connected to a database mapping subjects to numbers such as each subject is mapped to a unique number, the search engine being further adapted to receive a search query from a third user comprising a subject identification, to query the database using the user name for retrieving the mapped number associated thereto, to search and locate the subject related information associated with the number over the data network and to report the subject related information to the third user. There is also provided a network for enhancing search of subject related information distributed over a data network.

### FIELD OF THE INVENTION

The present invention is generally related to online searches over data networks, and more particularly to a method, system, search engine and a network for enhancing search of information over a data network.

### BACKGROUND OF THE INVENTION

Traditional methods and systems of data searches over data networks, such as the Internet, are based on alphabetic search queries. This is because user and/or object related information over these data networks are traditionally represented using alphabetic data including alphabetic keywords. Searching information of a specific user or object over a data network is generally time consuming because of the similarity of names with other non related users or objects over the data network. A lot of researches have been conducted for enhancing alphabetic based searches, which is yet to be efficient. Alphabetic based searches poses a lot of problems and have limitations such as the accuracy of located information, the latency in locating the search results, and the complexity of the process for filtering the search results.

### SUMMARY OF THE INVENTION

It is an object of the present invention to eliminate the disadvantages of the prior art by providing a method, a system, a network and a search engine for enhancing search of subject related information distributed over a data network. It should be understood that the subject can be a user such as a person, company, government or any other natural or legal person. The subject can also be an object, such as a building, a pet, a land or any other object. The subject can also be a matter of discussion or any other subject of any type, form or nature.

As a first aspect of the invention, there is provided a method of enhancing search of subject related information distributed over a data network, the method comprising (1) allocating a number to a subject over a data network for the purpose of using the number as means for identifying the subject over the data network; and (2) mapping subject related information distributed over the data network to the number such that the subject related information becomes searchable over the data network using the number.

Preferably, the method further comprises enabling third users over the data network to locate the subject related information distributed over the data network pursuant to a search query using the allocated number.

Preferably, the method further comprises storing data network links pointing to the subject related information in a database in association with the number, wherein the enabling third users to locate the subject related information comprises enabling the third users to query the database using the number for accessing the data network links.

Preferably, the enabling the third users to query the database using the number for accessing the data network links is carried out using a third processing unit connected to a user interface and to the database, the user interface being accessible to the third users through the data network.

Preferably, the allocation of the number to the subject is carried out by a first processing unit.

Preferably, the first processing unit is adapted to allocate the number to the subject based on available numbers such as the number allocated to the subject is unique with respect to other numbers previously allocated to other subjects over the data network.

Preferably, the first processing unit is adapted to provide for the possibility of choosing the number as a function of number allocation criteria comprising the available numbers.

Preferably, the subject is a user over the data network having a user status and a user country of residence, the user status being a person, a company or a government, wherein the number allocation criteria as a function of which the number is allocated further comprises the user status and the user country of residence.

Preferably, each number among the available numbers has a price, and wherein the first processing unit is adapted to provide the price of the chosen number to the user, to request and process the payment of the price as a condition to the allocation of the number.

The mapping of the subject related information to the number can comprise searching and locating by a second processing unit connected to the data network the subject related information over the data network using search parameters.

Preferably, the search parameters comprise a description or identification of the subject.

The mapping of the subject related information to the number comprises can comprise enabling a user to provide a list of data network links pointing to the subject related information using a user interface connected to a second processing unit and storing the data network links in association with the number in a database.

Preferably, the data network is the World Wide Web.

The subject related information can for example be user related information comprising social network profiles or contact information of a user.

As a further aspect of the invention, there is provided a system for enhancing search of subject related information distributed over a data network, the system comprising (1) a first processing unit adapted to be connected to the data network for allocating a number to a subject over the data network for the purpose of using the number as means for identifying the subject over the data network; and (2) a second processing unit adapted to be connected to the data network for mapping subject related information distributed over the data network to the number such as the subject related information becomes searchable over the data network using the number.

Preferably, the system further comprises a third processing unit adapted to be connected to the data network for enabling third users over the data network to locate the subject related information distributed over the data network pursuant to a search query using the allocated number.

Preferably, the system further comprises a database adapted to be connected to the third processing unit for storing data network links pointing to the subject related information in association with the number; and a first user interface adapted to be connected to the third processing unit and to the data network for enabling the third users to query the database over the data network using the number for accessing the data network links.

Preferably, the second processing unit is further adapted to be connected to a search engine over the data network for searching and locating the subject related information using search criteria for the purpose of the mapping.

Preferably, the search criteria comprise an alphabetic description or identification of the subject.

Preferably, the system further comprises (1) a database adapted to be connected to the second processing unit; (2) a second user interface adapted to be connected to the second processing unit and to the data network for enabling a user to conduct the mapping manually, the mapping comprising providing by the user a list of data network links pointing to the subject related information and storing the data network links inside the database.

Preferably, the first processing unit is further adapted to allocate the number to the subject based on available numbers such as the number allocated to the subject is unique with respect to other numbers previously allocated to other subjects over the data network.

Preferably, the first processing unit is further adapted to provide for the possibility of choosing the number as a function of number allocation criteria comprising the available numbers.

Preferably, the subject is a user having a user status and a user country of residence, the user status being a person, a company or a government, wherein the number allocation criteria as a function of which the number is allocated further comprises the user status and the user country of residence.

Preferably, each number among the available numbers has a price, and wherein the first processing unit is further adapted to provide the price of the chosen number to the user, to request and process the payment of the price as a condition to the allocation of the number.

Preferably, the data network is the World Wide Web.

Preferably, the subject related information is user related information comprising social network profiles or contact information of a user.

As a further further aspect of the invention, there is provided a search engine for enhancing search of subject related information distributed over a data network, the search engine being adapted to be connected to a database mapping subjects to numbers such as each subject is mapped to a unique number, the search engine being further adapted to receive a search query from a third user comprising a subject identification, to query the database using the user name for retrieving the mapped number associated thereto, to search and locate the subject related information associated with the number over the data network and to report the subject related information to the third user.

Preferably, the search engine is adapted to search and locate text, voice and video related content.

Preferably, the subject related information is user related information and the subject identification comprises a name of the user.

As another aspect of the invention, there is provided a network for enhancing search of subject related information distributed over a data network, the network comprising (1) a data network; (2) a user interface adapted to be connected to the data network; (3) a server adapted to be connected to the data network and to the user interface for receiving information associated with subjects over the data network, for mapping the information to a number unique to the subject and for posting the information in association with the number over the data network, the number being either specified by a user or allocated by the server; and (4) a search engine adapted to be connected to the data network for enabling third users over the data network to search and locate the information pursuant to a search query using the number.

Preferably, the data network comprises at least one of text, voice and video related content.

Preferably, the subject is a user over the data network, and the user related information is user related information.

### BRIEF DESCRIPTION OF THE DRAWINGS

FIG. 1 is a flow chart illustrating a method of enhancing search of subject related information over a data network according to an embodiment herein;

FIG. 2 is a flow chart illustrating the steps of mapping subject related information to a number over a data network according to an embodiment herein;

FIG. 3 is a flow chart illustrating the steps of mapping subject related information to a number over a data network according to another embodiment herein;

FIG. 4 is a bloc diagram illustrating a system for enhancing search of subject related information over a data network according to an embodiment herein;

FIG. 5 is a bloc diagram illustrating the interaction between a user and the first processing unit through the data network for the allocation of the number according to an embodiment herein;

FIG. 6 is a bloc diagram illustrating the interaction between a user and the second processing unit through the data network for the manual mapping of the user related information according to an embodiment herein;

FIG. 7 is a bloc diagram illustrating the interaction between the second processing unit and the search engine through the data network for the automatic mapping of the subject related information according to an embodiment herein; and

FIG. 8 is a bloc diagram illustrating the interaction between third users and the third processing unit through the data network for searching subject related information in a database using the number according to an embodiment herein;

FIG. 9 is a bloc diagram illustrating the interaction between third users and the third processing unit through the data network for searching subject related information over the data network using the number according to an embodiment herein;

FIG. 10 is a bloc diagram illustrating a search engine according to an embodiment herein; and

FIG. 11 is a bloc diagram illustrating a network according to an embodiment herein.

### DETAILED DESCRIPTION OF THE INVENTION

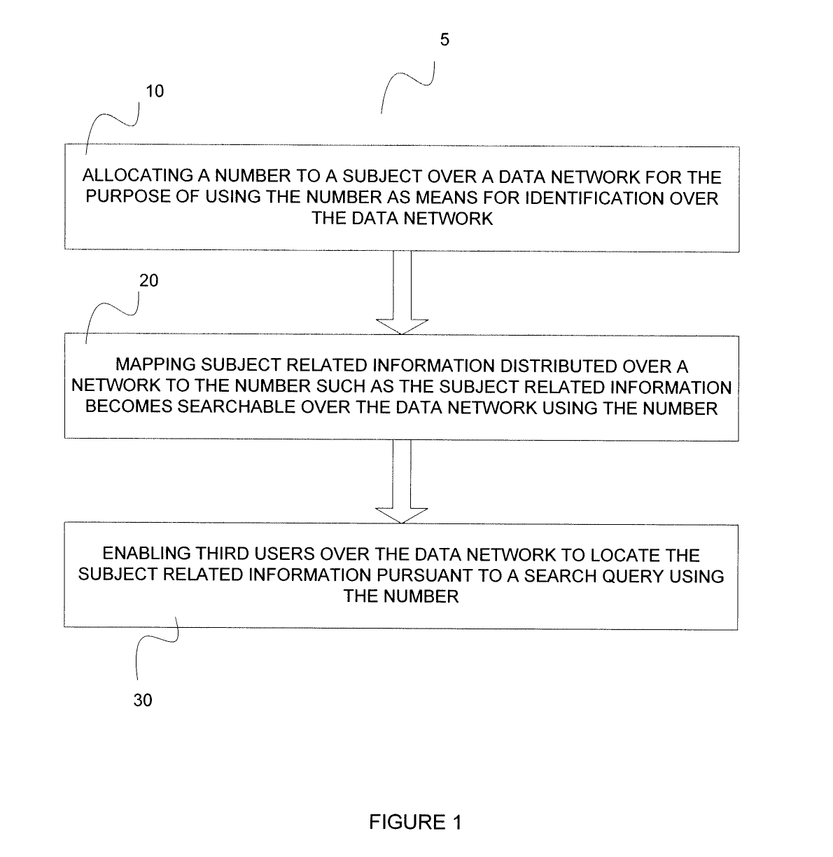

As a first aspect of the invention, as illustrated in FIG. 1, there is provided a method 5 of enhancing search of subject related information distributed over a data network 5. The method 5 comprises allocating a number to a subject over a data network for the purpose of using the number as means for identifying the subject over the data network 10, and mapping subject related information distributed over the data network to said number such that the subject related information becomes searchable over the data network using said number 20.

The subject can also be an object, such as a building, a pet, a land or any other object. The subject can also be a matter of discussion or any other subject of any type, form or nature.

In an embodiment herein, the allocation of the number 10 to the subject is conducted manually by an administrator.

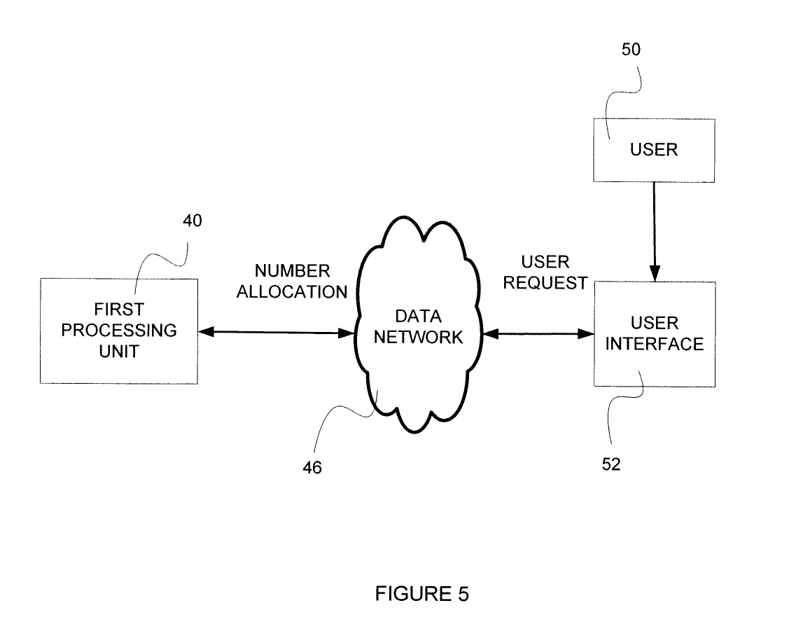

In an embodiment herein, the allocation of the number 10 is conducted using a first processing unit 40 connected to the data network 46 (see FIG. 5). The first processing unit 40 can for example be hosted in a server (not shown) comprising a network interface (not shown) connected to the data network 46.

In an embodiment herein, the number allocation 10 is conducted subsequent to a request made by a user 50 to the first processing unit 40 through the data network 46 for having a number allocated thereto for the purpose of identification over the data network (see FIG. 5).

In an embodiment herein, the number allocation request is carried out using a user interface 52 connected to the first processing unit 40 through the data network 46.

In an embodiment herein, the number allocation is conducted by the first processing unit 40 subsequent to a request made by another interested party such as a data network administrator, a search engine administrator and the like.

In an embodiment herein, the first processing unit 40 is programmed for automatically identifying subjects of the data network 46 and for allocating them unique identification numbers for the purpose of their identification over the data network 46.

The second step of the method 5 is to map subject related information distributed over the data network to the number such that the subject related information becomes searchable over the data network using the number 20.

The mapping can be carried out in different manners depending on the application.

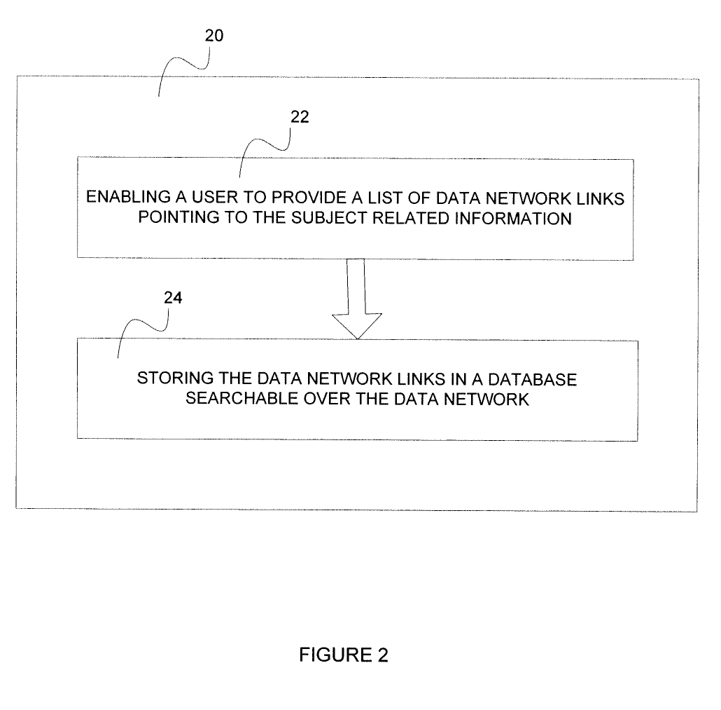

In an embodiment herein, as illustrated in FIG. 2, the mapping step 20 comprises enabling a user to provide a list of a data network links pointing to the subject related information 22.

In an embodiment herein, the mapping step 20 comprises storing the data network links in a database searchable over the data network 24.

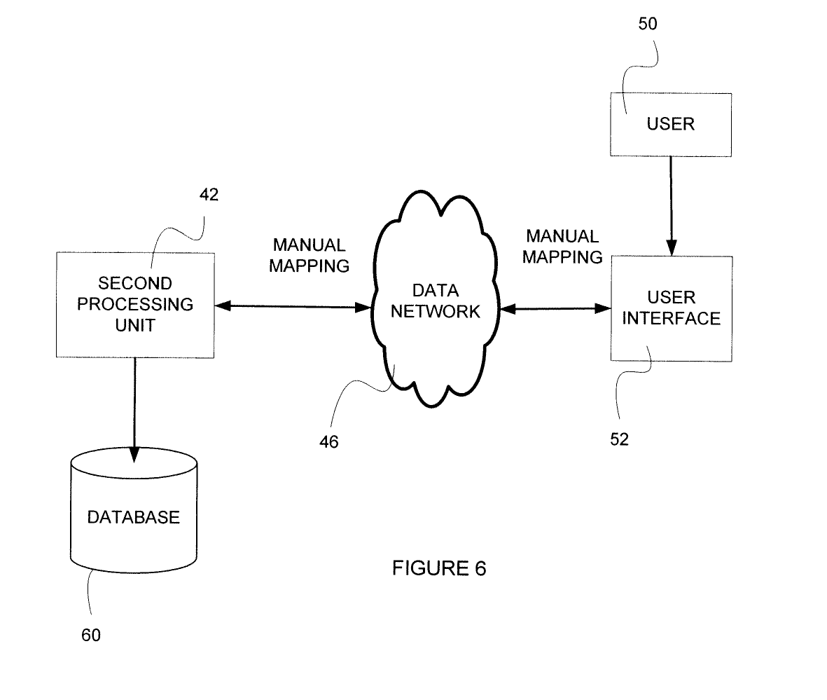

In an embodiment herein, as illustrated in FIG. 6, the mapping is carried out manually by the user 50 using a user interface 52 connected to the second processing unit 42 through the data network 46.

As an example, in case where the data network 46 is the World Wide Web, the user interface 52 can be a Web site adapted to receive the data network links from the user 50 and to send these to the second processing unit 42 through the Web. The data network links can be in this case Web links such as HTTP links. When the subject is a user, the subject related information can be user related information and the data network links can be pointing to user related information such as social network related profiles of the user or links to other user related information available on the Web.

The second processing unit 42 receives these data network links and stores it inside the database 60. The database 60 can be made available for third users 48 over the data network 46 as explained below.

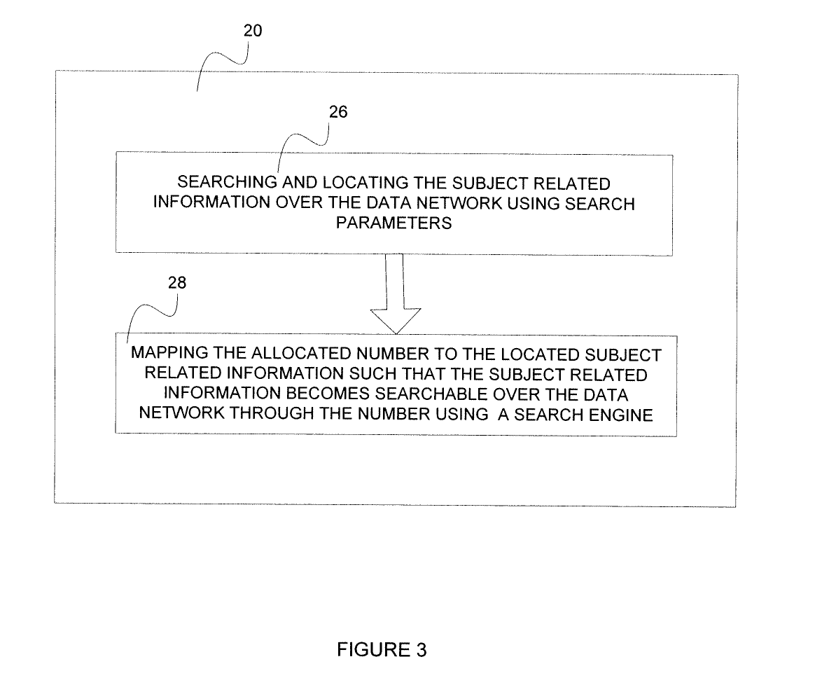

In an embodiment herein, as illustrated in FIG. 3, the mapping step 20 comprises searching and locating the subject related information over the data network using search parameters 26, and mapping the allocated number to the located subject information such that this information becomes searchable over the data network through the number using a search engine 28. This is an automatic mapping of the subject related information.

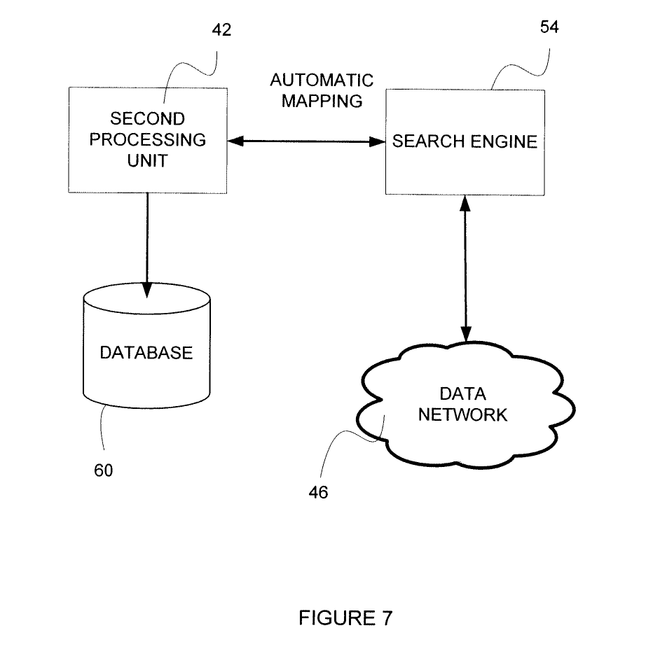

In an embodiment herein, as illustrated in FIG. 7, the mapping step 20 is conducted using a second processing unit 42 connected to a data network 46 through a search engine 54. In this case, the second processing unit 42 instructs the search engine 54 to conduct the search using search parameters comprising an identification or description of the subject. Where the subject is a user, the search parameters can comprise the name and/or address of the user and/or any other alphabetic information of the user. The search engine 54 searches and locates subject related information.

In an embodiment herein, the second processing unit 42 receives through the search engine 54 data network links associated with the located subject related information for storage inside the database 60.

In an embodiment herein, the second processing unit 42 maps the located subject related information to the allocated number at the hosting location of the subject related information. This enables third users to locate the subject related information at their normal hosting locations by querying the allocated subject number.

The mapping of the allocated number to the subject related information at the hosting location can be done according to techniques known in the art. In case where the data network is the World Wide Web, this can be done for example by adding the number as a keyword inside the website where the information is hosted.

In an embodiment herein, as illustrated in FIG. 1, the method 5 further comprises enabling third users over the data network to locate the subject related information pursuant to a search query using the number 30.

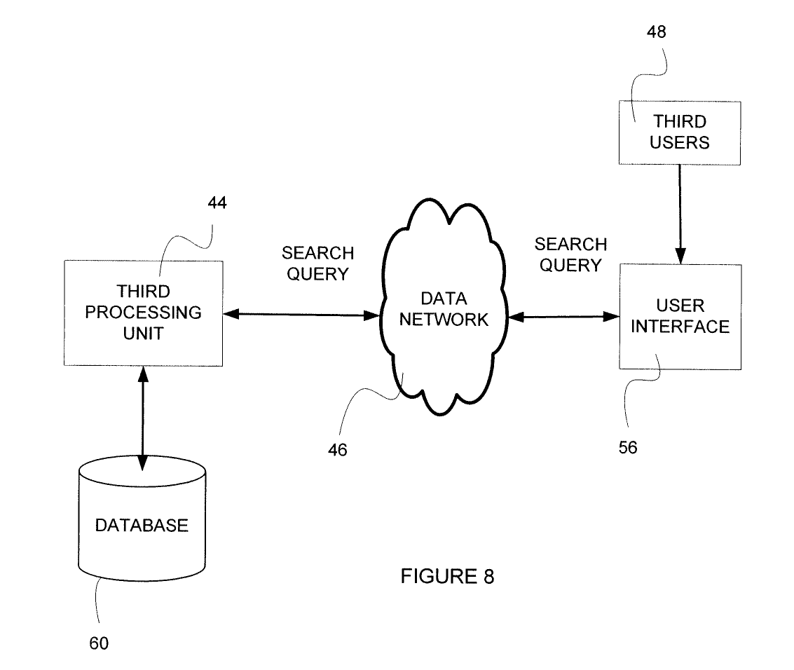

In an embodiment herein, as illustrated in FIG. 8, there is provided a third processing unit 44 adapted to be connected to the database 60 for receiving and processing queries for data network links associated with the allocated number.

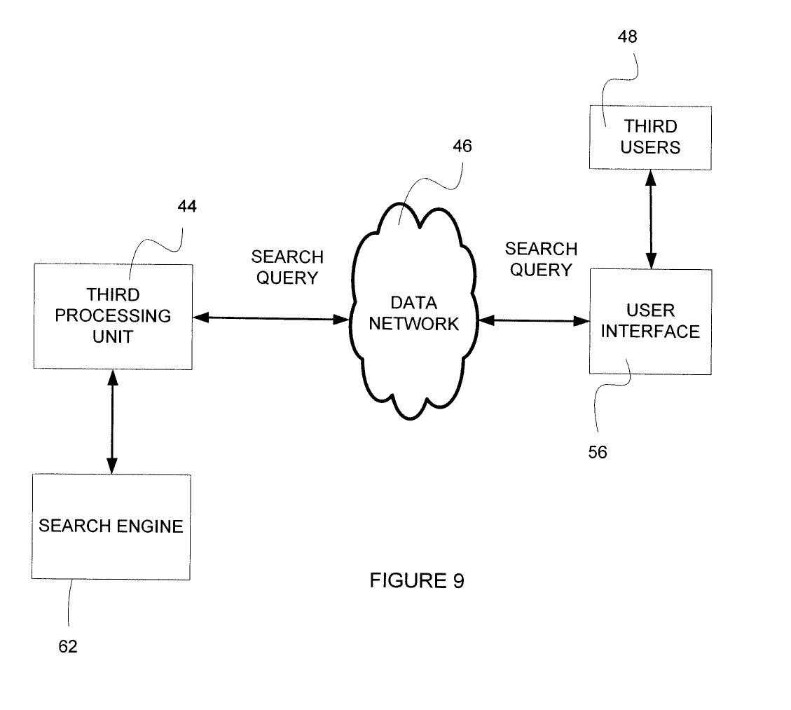

In an embodiment herein, as illustrated in FIG. 9, there is provided a third processing unit 44 adapted to be connected to a search engine 62 for receiving and processing queries for subject related information over the data network 46 associated with the allocated number.

In an embodiment herein, as illustrated in FIG. 8, there is further provided a user interface 56 adapted to be connected to the data network 46 and to third users 48 for receiving queries from the third users 48 and sending these over the data network 46 to the third processing unit 44 for processing. The queries of the third users 48 comprise the number allocated to the subject for whom they wish to receive the data network links. The third processing unit 44 receives and processes the queries by querying the database 60 using the subject allocated number. The database 60 returns the data network links to the third processing unit 44 which are then transmitted to the third users 48 via the data network 46 and the user interface 56. When the data network 46 is the World Wide Web, the user interface 56 can be a Web site adapted to receive the search queries of third users 48 and to transmit these to the third processing unit 44 for processing.

In an embodiment herein, as illustrated in FIG. 9, when the mapping of the subject related information is carried out at the hosting location on the data network, the third processing unit 44 searches the data network 46 using the subject allocated number and locates any subject related information mapped to the number. The third processing unit 44 is adapted to be connected to a search engine 62 for conducting the searches over the data network 46.

In an embodiment herein, as illustrated in FIG. 9, there is further provided a user interface 56 adapted to be connected to the data network 46 and to third users 48 for receiving queries from the third users 48 and sending these over the data network 46 to the third processing unit 44 for processing. The third processing unit 44 instructs the search engine 62 to search the data network and returns to the third users 48 via the data network 46 and the user interface 56 the located subject related information mapped to specified number.

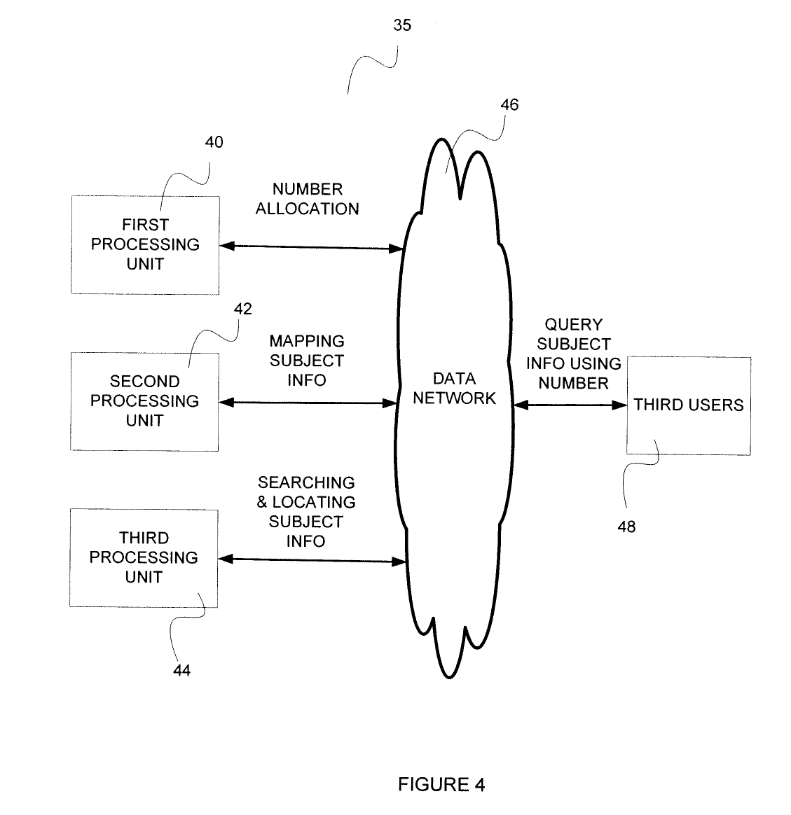

As another aspect of the invention, as illustrated in FIG. 4, there is provided a system 35 for enhancing search of subject related information distributed over a data network 46, the system comprising a first processing unit 40 adapted to be connected to the data network 46 for allocating a number to a subject over the data network 46 for the purpose of using the number as means for identifying the subject over the data network, and a second processing unit 42 adapted to be connected to the data network for mapping subject related information distributed over the data network 46 to said number such as the subject related information becomes searchable over the data network 46 using said number.

As an embodiment herein, the system 35 further comprises a third processing unit 44 adapted to be connected to the data network 46 for enabling third users 48 over the data network to locate the subject related information distributed over the data network 46 pursuant to a search query using the allocated number.

In an embodiment herein, the system further comprises a user interface 52 adapted to be connected to the first processing unit 40 over the data network 46 for enabling a user to make a request for the allocation of the number (see FIG. 5).

In an embodiment herein, the system further comprises a database 60 adapted to be connected to the second processing unit 42, and a user interface 52 adapted to be connected to the second processing unit 42 and to the data network 46 for enabling a user to conduct the mapping manually, the mapping comprising providing by the user a list of data network links pointing to the subject related information and storing the data network links inside the database 60 (see FIG. 6).

In an embodiment herein, the second processing unit 42 is further adapted to be connected to a search engine 54 over the data network for searching and locating subject related information using search criteria for the purpose of the mapping. The second processing unit 42 is adapted to map the located subject related information to the allocated subject number (see FIG. 7). The search criteria can comprise an identification or description of the subject. In case where the subject is a user, the search criteria comprise for example the name/address of the user or other information.

In an embodiment herein, the mapping is conducted by the second processing unit 42 at the location of the subject related information (at the hosting location). In this sense, the subject number is mapped to the located subject related information is such a manner that this information becomes searchable by a search engine or otherwise using the subject number. This can be conducted according to methods known in the art such as adding the number as a keyword to the description of the information or otherwise.

In an embodiment herein, there is also provided a database 60 adapted to be connected to the third processing unit 44 for storing data network links pointing to said located subject related information in association with the number. In this case, the mapping is conducted locally in the sense that the data network links for the located information are stored in the database 60.

In an embodiment herein, the first user interface 56 is adapted to be connected to the third processing unit 44 and to the data network 46 for enabling the third users to query the database 60 over the data network 46 using the number for accessing the data network links (see FIG. 8).

In an embodiment herein, there is provided a search engine 62 adapted to be connected to the third processing unit 44 and to the data network 46 for receiving search queries comprising the subject number and searching and locating subject related information distributed over the data network 62 mapped to this number (see FIG. 9).

In an embodiment herein, the request for such search queries come from the third users 48 using the user interface 56.

In an embodiment herein, the first processing unit 40, the second processing unit 44 and the third processing unit 56 are a single processing unit. In this case, the single processing unit can be hosted in a computer server (not shown) adapted to be connected to the data network 46.

In another embodiment herein, the first processing unit 40, the second processing unit 44 and the third processing unit 56 are different processing units located at the same of different locations.

In an embodiment herein, the data network 46 is a local area network, a medium area network or a wide area network such as the World Wide Web.

In an embodiment herein, data network 46 comprises text, voice and/or video content and/or a combination of these.

In an embodiment herein, the subject is a user and the data network links are Web links such as social network user related profiles and/or contact information and/or any other user information.

In an embodiment herein, the first processing unit 40 is further adapted to allocate the number to the subject based on available numbers such as the number allocated to the subject is unique with respect to other numbers previously allocated to other subjects over the data network.

In an embodiment herein, the first processing unit 40 is further adapted to provide for the possibility of choosing the number as a function of number allocation criteria comprising the available numbers.

In an embodiment herein, the subject is a user having a user status and a user country of residence, the user status being a person, a company or a government, wherein the number allocation criteria as a function of which the number is allocated further comprises the user status and the user country of residence.

In an embodiment herein, each number among the available numbers has a price, and wherein the first processing unit 40 is further adapted to provide the price of the chosen number to the requested user, to request and process the payment of the price as a condition to the allocation of the number.

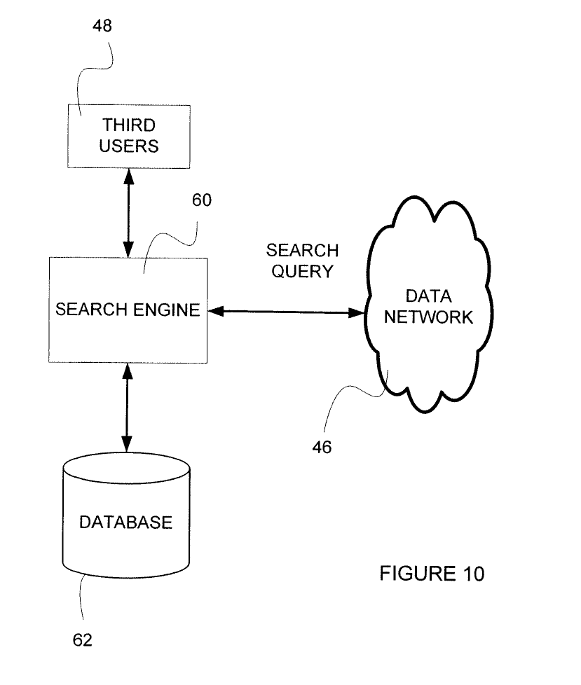

As a further aspect of the invention, as illustrated in FIG. 10, there is provided a search engine 60 for enhancing search of subject related information distributed over a data network 46, the search engine being adapted to be connected to a database 62 mapping subjects to numbers such as each subject is mapped to a unique number, the search engine 60 being further adapted to receive a search query from a third user 48 comprising a subject description or identification, to query the database 62 using the subject description or identification for retrieving the mapped number associated thereto, to search and locate the subject related information associated with said number over the data network 46 and to report said subject related information to said third user 48.

As an embodiment herein, the subject is a user and the subject description or identification comprises the name of the user.

As an embodiment herein, the search engine 60 is adapted to search and locate text, voice and/or video related content and/or a combination thereof.

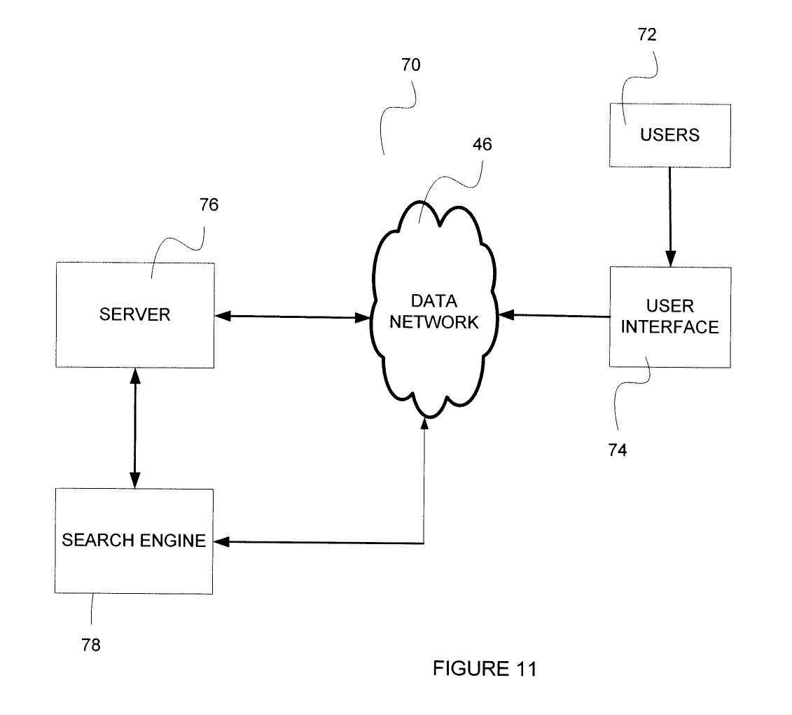

As a further aspect of the invention, as illustrated in FIG. 11, there is provided a network 70 for enhancing search of subject related information distributed over a data network, the network comprising:
a data network 46;
a user interface 72 adapted to be connected to the data network;
a server 74 adapted to be connected to the data network and to the user interface 72 for receiving information associated with subjects over the data network 46, for mapping the information to a number unique to the subject and for posting the information in association with the number over the data network 46, the number being either specified by the subject or allocated by the server 74; and
a search engine 76 adapted to be connected to the data network 46 for enabling third users over the data network to search and locate said information pursuant to a search query using said number.

Although the above description of the present invention has disclosed the features of the invention as applied to the preferred embodiment; additions, omissions and modifications applied to the details of the embodiment illustrated may be made by those skilled in the art without departing from the essential characteristic of the present invention.

1. A search engine for enhancing search of subject related information distributed over a data network, the search engine being adapted to be connected to a database mapping subjects to numbers such as each subject is mapped to a unique number, the search engine being further adapted to receive a search query from a third user comprising a subject identification, to query the database using the user name for retrieving the mapped number associated thereto, to search and locate the subject related information associated with said number over the data network and to report said subject related information to said third user.

2. The search engine of claim 1, wherein the search engine is adapted to search and locate text, voice and video related content.

3. The search engine of claim 2, wherein the subject is a user, and the subject related information is user related information and the subject identification comprises a name of the user.

4. A network for enhancing search of subject related information distributed over a data network, the network comprising:
a data network;
a user interface adapted to be connected to the data network;
a server adapted to be connected to the data network and to the user interface for receiving information associated with subjects over the data network, for mapping the information to a number unique to the subject and for posting the information in association with the number over the data network, the number being either specified by a user or allocated by the server; and
a search engine adapted to be connected to the data network for enabling third users over the data network to search and locate said information pursuant to a search query using said number.

5. The network of claim 4, wherein said data network comprises at least one of text, voice and video related content.

6. The network of claim 5, wherein the subject is a user over the data network, and the user related information is user related information.
